(19) United States
(12) Patent Application Publication
(10) Pub. No.: US 2021/0076665 A1
(43) Pub. Date: Mar. 18, 2021

(54) Sealed Diaphragm Game Call

(71) Applicant: John Jordan, Detroit Lakes, MN (US)

(72) Inventor: John Jordan, Detroit Lakes, MN (US)

(21) Appl. No.: 16/572,141

(22) Filed: Sep. 16, 2019

(51) Int. Cl. A01M 31/00

(52) U.S. Cl. CPC A01M 31/004

(57) ABSTRACT

A sealed diaphragm game call for efficiently calling and attracting wild animals. The sealed diaphragm game call generally includes a call base with an upper surface, a rigid frame, and a diaphragm, which, together, forms a diaphragm call assembly. The game call may also comprise a custom-molded sealant portion. The sealed diaphragm game call is a custom-fit game call that may be made by applying a curable sealant to the upper surface of the call base, inserting the call base in a user's mouth, pressing the call base toward the roof of the user's mouth, and holding the call base in position against the roof of the user's mouth until the curable sealant has cured. After curing, the sealant is bonded to the diaphragm call assembly, and specifically, the upper surface of the call base and the upper surface of the rigid frame.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a sealed diaphragm game call for more efficient use of the game call by preventing air escaping from the upper aspect of the call.

### Related Art

Any discussion of the related art throughout the specification should in no way be considered as an admission that such related art is widely known or forms part of common general knowledge in the field.

Diaphragm-type game calls (as well as other types of calls) have been used for years to simulate sounds made by wild animals, in order to attract the animals closer to hunters, wildlife enthusiasts, photographers, etc. Diaphragm calls are commonly used for attracting wild turkeys and elk, for example, and are generally known to be hard to master. Diaphragm calls are also typically known as “mouth calls,” since they are placed entirely within a user's mouth when in use. The mouth calls are generally U-shaped, with the open portion of the “U” facing toward the front, with a vibrating diaphragm (such as a latex diaphragm) held within a rigid U-shaped frame.

As mentioned, typical diaphragm-type mouth calls require a great deal of skill and practice, as well as the use of a hunter's tongue, to hold the call against the roof of the user's mouth. The tongue is positioned to create a gap between the tongue and the diaphragm. Further, even when used properly, conventional mouth calls may allow air to escape and flow between the upper surface of the call and the roof of the user's mouth, greatly reducing efficiency, and contributing to their difficulty of use.

### SUMMARY

An example embodiment is directed to a sealed diaphragm game call. The sealed diaphragm game call includes a call base having an upper surface, a rigid frame, and a diaphragm, which, together, comprises a diaphragm call assembly. The game call may also comprise a custom-molded sealant portion. The sealed diaphragm game call is a custom-fit game call that may be made by a process comprising the steps of applying a curable sealant to the upper surface of the call base, inserting the call base in a user's mouth, pressing the call base toward the roof of a user's mouth, and holding the call base in position against the roof of the user's mouth until the curable sealant has cured. After curing, the sealant is bonded to the diaphragm call assembly, and specifically, the upper surface of the call base and the upper surface of the rigid frame.

In some example embodiments, the cured sealant remains compliant after being cured. Furthermore, the cured sealant may comprise the sealant portion. The sealant portion may be permanently bonded to the call base. The sealant portion may also be permanently bonded to the upper surface of the rigid frame, so that the sealant portion forms a substantially continuous upper surface that matches the contours of the roof of the user's mouth. Being compliant, the sealant portion may create an airtight palatal seal that increases the efficiency of the game call.

There has thus been outlined, rather broadly, some of the embodiments of the sealed diaphragm game call in order that the detailed description thereof may be better understood, and in order that the present contribution to the art may be better appreciated. There are additional embodiments of the sealed diaphragm game call that will be described hereinafter and that will form the subject matter of the claims appended hereto. In this respect, before explaining at least one embodiment of the sealed diaphragm game call in detail, it is to be understood that the sealed diaphragm game call is not limited in its application to the details of construction or to the arrangements of the components set forth in the following description or illustrated in the drawings. The sealed diaphragm game call is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a call assembly for use in making a sealed diaphragm game call in accordance with an example embodiment.

FIG. 2 is a top view of a call assembly for use in making a sealed diaphragm game call in accordance with an example embodiment.

FIG. 3 is a front view of a call assembly for use in making a sealed diaphragm game call in accordance with an example embodiment.

FIG. 4 is a side view of a call assembly for use in making a sealed diaphragm game call in accordance with an example embodiment.

FIG. 5 is a bottom view of a call assembly for use in making a sealed diaphragm game call in accordance with an example embodiment.

FIG. 6 is a perspective view of a call assembly being prepared for use in making a sealed diaphragm game call in accordance with an example embodiment.

FIG. 7 is a perspective view of part of a process for making a sealed diaphragm game call in accordance with an example embodiment.

FIG. 8 is a top view of a sealed diaphragm game call in accordance with an example embodiment.

FIG. 9 is a perspective view of a sealed diaphragm game call in accordance with an example embodiment.

FIG. 10 is another perspective view of a sealed diaphragm game call in accordance with an example embodiment.

FIG. 11 is a sectional view of a sealed diaphragm game call taken at line 11-11 of FIG. 8 in accordance with an example embodiment.

FIG. 12 is a sectional view of a sealed diaphragm game call taken at line 12-12 of FIG. 8 in accordance with an example embodiment.

### DETAILED DESCRIPTION

### A. Overview

An example sealed diaphragm game call 10 generally comprises a call base 22 having an upper surface 24, a rigid frame 28, and a diaphragm 27, which, together, comprises a diaphragm call assembly 20. The game call may also comprise a custom-molded sealant portion 30. The sealed diaphragm game call 10 is a custom-fit game call that may be made by a process comprising the steps of applying a curable sealant 32 to the upper surface 24 of the call base 22 and the upper surface 29 of rigid frame 28, inserting the call base 22 in a user's mouth, pressing the call base 22 toward the roof of the user's mouth, and holding the call base 22 in position against the roof of the user's mouth until the curable sealant 32 has cured.

The game call 10 may be customized using the process described above, which may only take about three minutes with an oral approved silicone-like dental material 32, for example, such as the type used to make flexible impressions of the mouth and teeth during dental procedures.

After curing, the sealant 32 comprises a sealant portion 30 that is bonded to the diaphragm call assembly 20, and specifically, to the upper surface 24 of the call base 22 and the upper surface 29 of the rigid frame 28. The cured sealant portion 30 also has an upper surface 34 that substantially conforms to the roof of an individual user's mouth after curing, thus creating an airtight seal (i.e., a complete palatal seal) between the call 10 and the roof of the user's mouth. The seal may be improved or be superior due to the compliant nature of the sealant 32 even after it has cured. Thus, in use, no air escapes and flows over the top of the call 10, so all of the airflow is directed past the flexible diaphragm 27, which makes the call 10 more efficient than calls that are not custom fit and sealed to an individual user's mouth.

After the sealant 32 has cured, the result is a sealed diaphragm game call 10 that is essentially a single unit, which is custom fit or molded to be a perfect fit for an individual user.

### B. Diaphragm Call Assembly

The game call 10 may be sold or provided as a kit, which may include a diaphragm-type call assembly 20 and flexible or compliant silicone-like sealant 32, which will generally be provided in uncured form. For example, the sealant 32 may be provided in a convenient one part or two part applicator tube or syringe 36, as shown in FIG. 6, although other forms may also be provided. The sealant 32 may be a compliant, dental-approved material, such as the type of material used for making flexible impressions of parts of people's mouths and teeth during dental procedures.

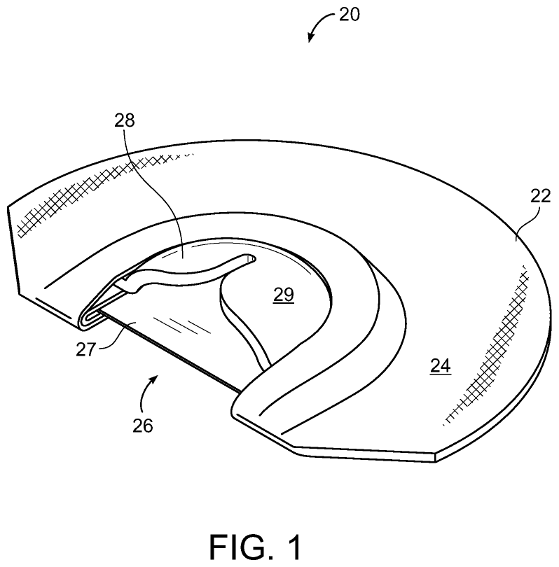

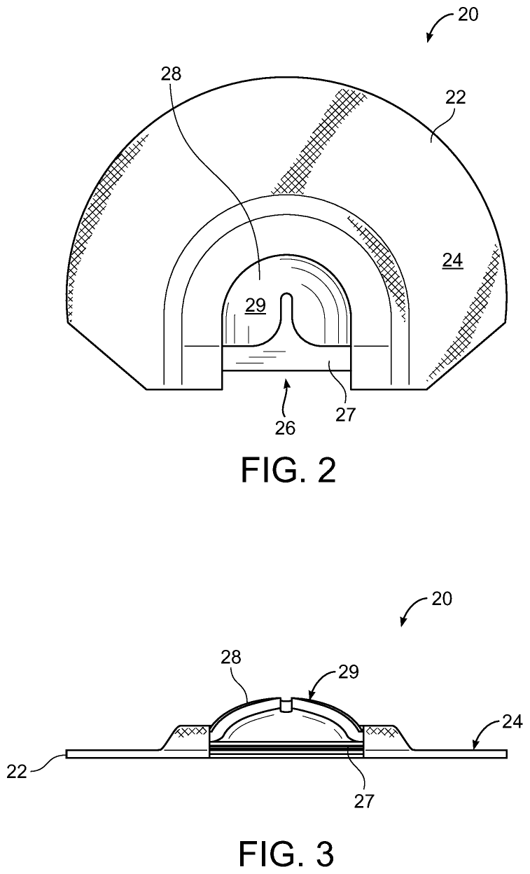

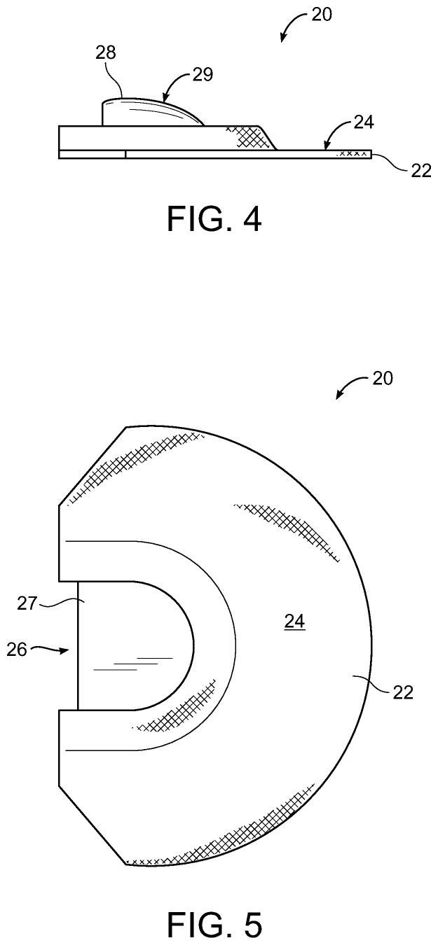

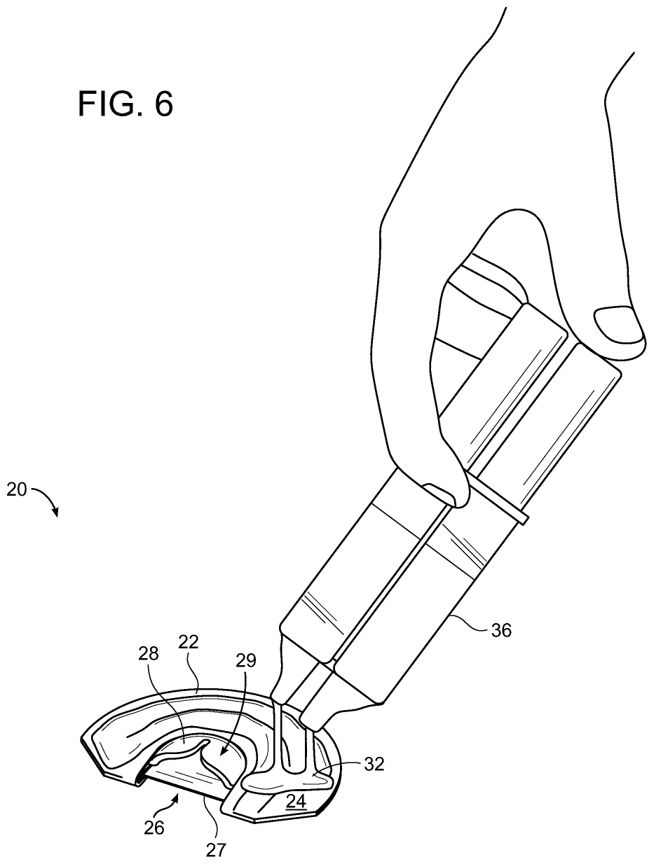

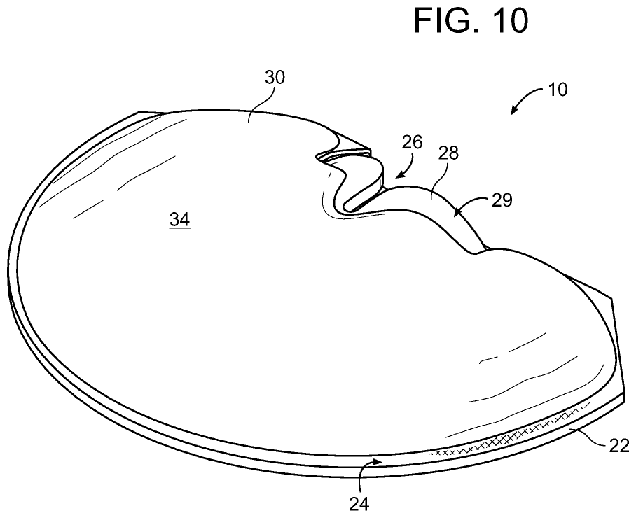

The call assembly 20 may include a call base 22 with an upper surface 24, which is generally curved to approximate the roof of a user's mouth, as shown for example in FIGS. 1, 3, and 4. As also shown in FIGS. 1, 2, and 5-10, when viewed from the top, the call assembly 20 is generally U-shaped, with an open recess 26 or flat portion of the “U” facing forward when the call is inserted in a user's mouth. As is known, such call assemblies may have several different shapes, sizes, and forms, just one of which is shown in the figures, although any type may be used as described herein to create the custom molded, sealed diaphragm call 10. For example, the shape and size, and overall configuration, may vary depending on what animal the call assembly 20 is designed for.

As perhaps best shown in FIGS. 1-5, the call assembly 20 includes the base 22, a rigid frame 28, which is generally held within the call base 22, and a flexible diaphragm 27, which is held in position as shown near a front-facing, central recess 26 of the assembly 20.

The call base 22 may be made of or include a somewhat flexible or compliant fabric or woven type of material, which provides a good base and material for the sealant 32 to be applied to in the process of making the sealed diaphragm call 10. However, the base 22 is typically rigid enough that the shape of the call assembly 20 is maintained. As discussed above, the call base 22 has an upper surface 24 that will be shaped to fit closely next to the roof of a user's mouth. The call base 22 also has a central recess 26 in which the rigid frame 28 and the diaphragm 27 it holds are positioned. Like the call base 22, the rigid frame 28 also has an upper surface 29. As will be described further below, the sealant 32 can be applied onto upper surfaces 24, 29 to adhere to them and to fill any gaps between those two surfaces, creating a single, uppermost surface 34 of sealant portion 30.

### C. Operation and Preparation of Preferred Embodiment

The sealed diaphragm game call 10 includes a call base 22 having an upper surface 24, a rigid frame 28, and a diaphragm 27, which comprises a diaphragm call assembly 20. The game call 10, after forming is complete, may also comprise a custom-molded sealant portion 30, which has an upper surface 34 that is a custom fit for the roof of an individual user's mouth. The completed sealed diaphragm game call 10 is a custom-fit game call that may be made by applying a curable sealant 32 to the upper surface 24 of the call base 22, as shown in FIG. 6. The “unfinished” game call 10 may be sold or provided with separate components, or may be sold as a kit, which would include one or more diaphragm call assemblies 20 and a sufficient quantity of uncured sealant 32, which may be provided in an applicator 36, for example, which may be applied to the call assembly 20.

The procedure for applying sealant 32 to a game call assembly 20 may only take about three minutes, using an oral approved silicone-like dental material 32, for example, such as the type used to make flexible impressions of the mouth and teeth during dental procedures. The sealant material 32 may be of the type that remains flexible or compliant after it is cured, providing for a comfortable, air-tight seal of the game call 10 in a user's mouth.

When applying sealant to the call body 22, a user may be instructed to cover all or most of the top surface 24 of the call body 22, and also to partly cover upper surface 29 of frame 28, thus filling any gaps or irregularities between the frame 28 and the body 22. Care should be taken, however, to avoid applying sealant too close to the central recess 26, which could affect the functioning of the call 10.

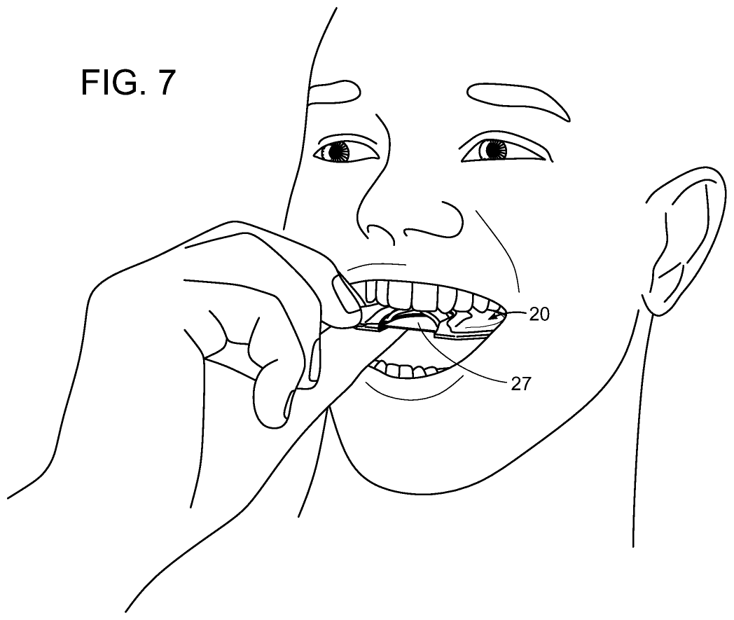

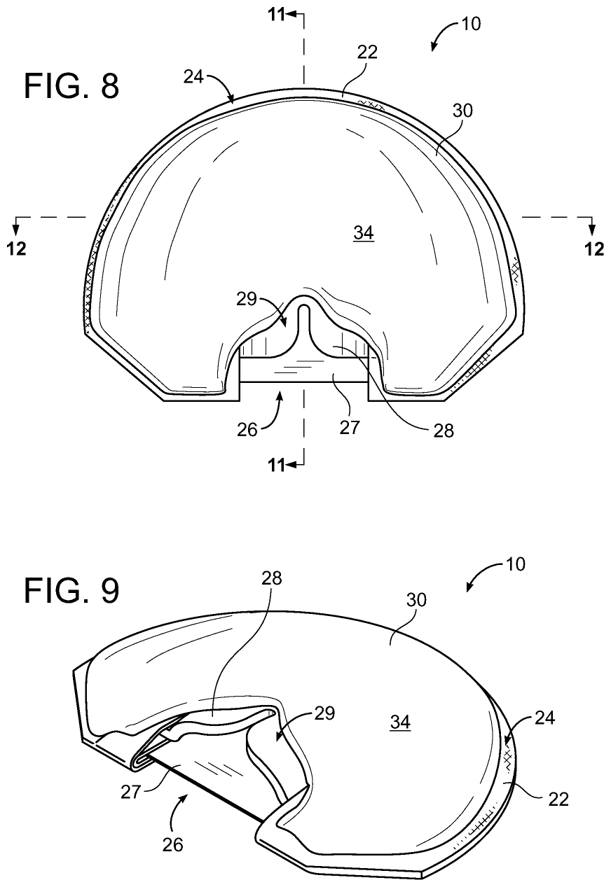

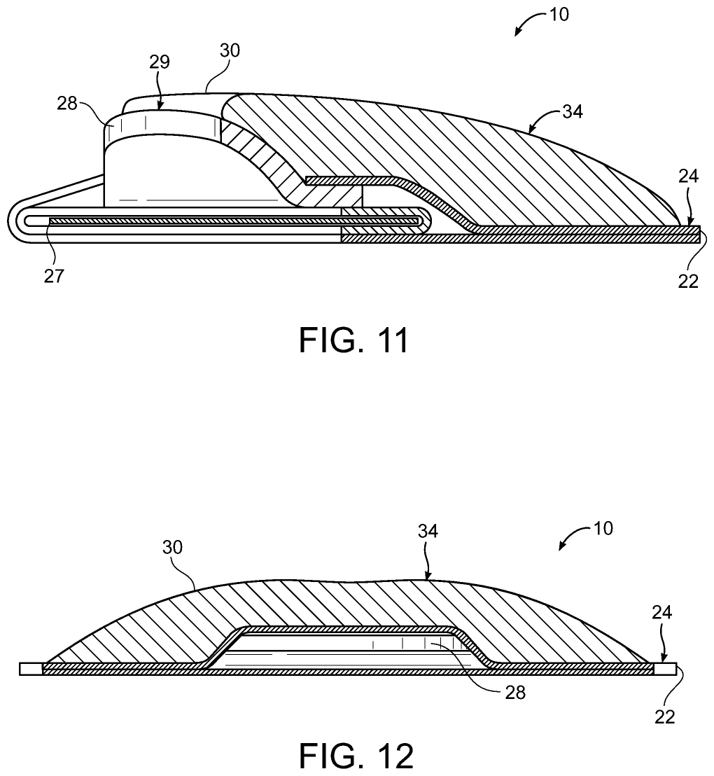

Next, the user can insert the call base 22 and the entire call assembly 20, with the uncured sealant 32 on the upper surface 24, in his or her mouth, in the position shown in FIG. 7. The user will then press the call base 22 toward the roof of the mouth, and will hold the call base 22 and the frame 28 in position against the roof of the mouth until the curable sealant 32 has cured. Once the sealant 32 has cured, it will form a sealant portion 30 on the top surface of the call assembly 20, as shown in FIGS. 8-12. After curing, the sealant 32 is bonded to the diaphragm call assembly 20, and specifically, to the upper surface 24 of the call base 22 and the upper surface 29 of the rigid frame 28. The frame 28 still holds the diaphragm 27 in position, as with the call assembly 20 before it has been customized.

Thus formed, the sealed diaphragm game call 10 will have a substantially smooth, continuous upper surface 34 covering all or most of the top of body 22 and also part of frame 28. This upper surface 34 of sealant portion 30 will form an air-tight fit with the roof of the user's mouth, which will make the call 10 more efficient and easier to use.

Unless otherwise defined, all technical and scientific terms used herein have the same meaning as commonly understood by one of ordinary skill in the art to which this invention belongs. Although methods and materials similar to or equivalent to those described herein can be used in the practice or testing of the sealed diaphragm game call, suitable methods and materials are described above.

All publications, patent applications, patents, and other references mentioned herein are incorporated by reference in their entirety to the extent allowed by applicable law and regulations. The sealed diaphragm game call may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A method of making a sealed diaphragm game call, comprising:
applying a curable sealant to an upper surface of a call base;
inserting the call base in a user's mouth;
pressing the call base toward a roof of the user's mouth; and
holding the call base in position against the roof of the user's mouth until the curable sealant has cured.

2. The sealed diaphragm game call of claim 1, wherein the cured sealant comprises a sealant portion.

3. The sealed diaphragm game call of claim 2, wherein the sealant portion is permanently bonded to the call base.

4. The sealed diaphragm game call of claim 1, wherein the cured sealant remains compliant after being cured.

5. The sealed diaphragm game call made using the method of claim 1.

6. The sealed diaphragm game call of claim 5, wherein the cured sealant remains compliant after being cured.

7. The sealed diaphragm game call of claim 5, wherein the cured sealant comprises a sealant portion.

8. The sealed diaphragm game call of claim 7, wherein the sealant portion is permanently bonded to the call base.

9. The sealed diaphragm game call of claim 7, wherein the sealant portion is bonded to the upper surface of the call base.

10. The sealed diaphragm game call of claim 7, wherein the sealant portion remains compliant after being cured.

11. The sealed diaphragm game call of claim 7, wherein the sealant portion is adapted to create an airtight palatal seal when the game call is in the user's mouth.

12. The sealed diaphragm game call of claim 11, wherein the sealant portion remains compliant after being cured.

13. A sealed diaphragm game call, made by a process comprising the steps of:
applying a curable sealant to an upper surface of a call base;
inserting the call base in a user's mouth;
pressing the call base toward a roof of the user's mouth; and
holding the call base in position against the roof of the user's mouth until the curable sealant has cured.

14. The sealed diaphragm game call of claim 13, wherein the cured sealant remains compliant after being cured.

15. The sealed diaphragm game call of claim 13, wherein the cured sealant comprises a sealant portion.

16. The sealed diaphragm game call of claim 15, wherein the sealant portion is permanently bonded to the call base.

17. The sealed diaphragm game call of claim 15, wherein the sealant portion is bonded to the upper surface of the call base and to an upper surface of a rigid frame.

18. The sealed diaphragm game call of claim 17, wherein the sealant portion remains compliant after being cured.

19. The sealed diaphragm game call of claim 18, wherein the sealant portion is adapted to create an airtight palatal seal when the game call is in the user's mouth.

20. The sealed diaphragm game call of claim 19, wherein the sealant portion remains compliant after being cured, such that the compliant sealant portion creates the airtight palatal seal.
